(19) United States
(12) Patent Application Publication
(10) Pub. No.: US 2026/0082356 A1
(43) Pub. Date: Mar. 19, 2026

(54) CODEBOOK CONFIGURATION FOR DEVICE POSITIONING

(71) Applicant: Lenovo (Singapore) Pte. Limited, Singapore (SG)

(72) Inventors: Khaled Nafez Rauf Ardah, Ilmenau (DE); Robin Rajan Thomas, Bad Nauheim (DE); Ali Ramadan Ali, Kraiburg (DE); Alexander Golitschek Edler von Elbwart, Darmstadt (DE); Karthikeyan Ganesan, Nauheim (DE); Abir Ben Hadj Fredj, Wiesbaden (DE)

(73) Assignee: Lenovo (Singapore) Pte. Limited, Singapore (SG)

(21) Appl. No.: 19/110,014

(22) PCT Filed: Sep. 11, 2023
(86) PCT No.: PCT/IB2023/059006

§ 371 Date: Mar. 7, 2025

Related U.S. Application Data
(60) Provisional application No. 63/406,466, filed on Sep. 14, 2022.

(51) Int. Cl. H04W 64/00; H04L 5/00; H04L 25/02; H04W 8/22

(52) U.S. Cl. CPC H04W 64/00; H04L 5/0051; H04L 25/0212; H04W 8/22

(57) ABSTRACT

Various aspects of the present disclosure relate to methods, apparatuses, and systems that support codebook configuration for device positioning. For instance, implementations provide for codebook configuration based on various criteria pertaining to network configuration entities (e.g., a location and mobility function (LMF)), target UE nodes (e.g., UEs for which position is to be determined) and/or positioning anchor nodes, e.g., nodes that transmit positioning reference signals (PRS). The criteria, for example, represent attributes of the different nodes that may affect codebook configuration and/or complexity. Using a configured codebook, a target UE can process received PRS to determine different position-related parameters of the target UE. The target UE can transmit the position-related parameters to a different node (e.g., a network entity) to enable the different node to process the position-related parameters to estimate a location of the target UE.

### RELATED APPLICATION

This application claims priority to U.S. Provisional Application Ser. No. 63/406,466 filed 14 Sep. 2022 entitled “CODEBOOK CONFIGURATION FOR DEVICE POSITIONING,” the disclosure of which is incorporated by reference herein in its entirety.

### TECHNICAL FIELD

The present disclosure relates to wireless communications, and more specifically to position determination in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for device positioning, such as for UE positioning. However, some techniques do not support efficient configuration of logic for device positioning that considers device attributes and/or use case particulars.

### SUMMARY

The present disclosure relates to methods, apparatuses, and systems that support codebook configuration for device positioning. For instance, implementations provide for codebook configuration based on various criteria pertaining to network configuration entities (e.g., a location and mobility function (LMF)), target UE nodes (e.g., UEs for which position is to be determined) and/or positioning anchor nodes, e.g., nodes that transmit positioning reference signals (PRS). The criteria, for example, represent attributes of the different nodes that may affect codebook configuration and/or complexity. Using a configured codebook, a target UE can process received PRS to determine different position-related parameters of the target UE. The target UE can transmit the position-related parameters to a different node (e.g., a network entity) to enable the different node to process the position-related parameters to estimate a location of the target UE.

By utilizing the described techniques, codebook configuration for position determination can be dynamically adapted to different device attributes and/or scenarios, such as to increase position determination accuracy and to reduce burden on system resources (e.g., power, processing, data transmission, etc.) as part of position estimation.

Some implementations of the methods and apparatuses described herein may further include generating, at a first apparatus, a notification including codebook configuration including codebook boundaries and a number of positioning reference signal features for forming a codebook of a second apparatus, the number of positioning reference signal features based at least in part on one or more criteria; transmitting the notification to the second apparatus; receiving positioning measurements generated by the second apparatus based at least in part on the codebook configuration; and generating a position estimate of the second apparatus based at least in part on the positioning measurements.

Some implementations of the methods and apparatuses described herein may further include: where the positioning reference signal features include one or more of a number of positioning reference signal codewords per dimension or a number of positioning reference signal beams per dimension; the one or more criteria include one or more of: one or more capabilities of the second apparatus; one or more positioning accuracy features of the first apparatus; a power usage parameter of the second apparatus; a maximum delay parameter of the first apparatus; a mobility status of the second apparatus; the codebook boundaries of the second apparatus; or a positioning reference signal time-frequency resource configuration of the second apparatus; further including transmitting positioning reference signals to the second apparatus; the position estimate of the second apparatus includes one or more of: an absolute position of the second apparatus; a relative position of the second apparatus; or a range estimate including of one or more of a distance or a relative direction with respect to one or more of the first apparatus or an apparatus that transmits positioning reference signals to the second apparatus; the positioning measurements are based at least in part on one or more of uplink, downlink, or sidelink positioning measurements; the first apparatus includes a network configuration entity and the second apparatus includes a UE; further including: receiving an indication of a change in the one or more criteria; and dynamically adjusting the codebook configuration based on the change in the one or more criteria.

Some implementations of the methods and apparatuses described herein may further include receiving, at a first apparatus, a notification including codebook configuration including codebook boundaries and a number of positioning reference signal features for forming a codebook of the first apparatus; generating a codebook based at least in part on the codebook configuration; receiving positioning reference signals; generating positioning measurements based at least in part on the positioning reference signals and the codebook; and transmitting the positioning measurements to a second apparatus.

Some implementations of the methods and apparatuses described herein may further include: where the positioning reference signal features include one or more of a number of positioning reference signal codewords per dimension or a number of positioning reference signal beams per dimension; generating the positioning measurements includes using codewords forming the codebook to process the positioning reference signals; further including processing one or more paths of channel impulse responses (CIR) to generate the positioning measurements; further including generating the positioning measurements using one or more codebook-based methods; the one or more codebook-based methods include multiple signal classification (MUSIC); further including generating the positioning measurements based at least in part on one or more of uplink, downlink, or sidelink positioning measurements; the first apparatus includes a UE, and the second apparatus includes one or more of an apparatus that transmits the notification or an apparatus that transmits the positioning reference signals.

Some implementations of the methods and apparatuses described herein may further include generating, at a first apparatus, a first notification including a codebook configuration of a second apparatus including codebook boundaries and a number of positioning reference signal beams for forming a codebook of the second apparatus, the number of positioning reference signal beams based at least in part on a first set of criteria; generating, at the first apparatus, a second notification including a codebook configuration of one or more third apparatus including codebook boundaries and a number of positioning reference signal beams for forming a codebook of the one or more third apparatus, the number of positioning reference signal beams based at least in part on a second set of criteria; transmitting the first notification to the second apparatus, and the second notification to the one or more third apparatus; receiving positioning measurements generated by the second apparatus based at least in part on the codebook configuration of the second apparatus; and generating a position estimate of the second apparatus based at least in part on the positioning measurements.

Some implementations of the methods and apparatuses described herein may further include: where one or more of the first set of criteria or the second set of criteria include one or more of: at least one of one or more capabilities of the second apparatus or one or more capabilities of the one or more third apparatus; one or more positioning accuracy features of the first apparatus; one or more of a power usage parameter of the second apparatus or a power usage parameter of the one or more third apparatus; a maximum delay parameter of the first apparatus; one or more of a mobility status of the second apparatus or a mobility status of the one or more third apparatus; one or more of the codebook boundaries of the second apparatus or the codebook boundaries of the one or more third apparatus; or one or more of a positioning reference signal time-frequency resource configuration of the second apparatus or a positioning reference signal time-frequency resource configuration of the one or more third apparatus; the position estimate of the second apparatus includes one or more of: an absolute position of the second apparatus; a relative position of the second apparatus; or a range estimate including of one or more of a distance or a relative direction with respect to one or more of the first apparatus or an apparatus that transmits positioning reference signals to the second apparatus; the positioning measurements are based at least in part on one or more of uplink, downlink, or sidelink positioning measurements; the first apparatus includes a network configuration entity, the second apparatus includes a UE, and the one or more third apparatus includes one or more apparatus that transmit positioning reference signals to the second apparatus.

Some implementations of the methods and apparatuses described herein may further include receiving, at a first apparatus, a notification including codebook configuration including codebook boundaries and a number of positioning reference signal beams for forming a codebook of the first apparatus; generating a codebook based at least in part on the codebook configuration; receiving beams that include positioning reference signals; generating positioning measurements based at least in part on one or more positioning reference signals from one or more beams with a strongest signal strength and the codebook; and transmitting the positioning measurements to a second apparatus.

Some implementations of the methods and apparatuses described herein may further include: where the beams that include the positioning reference signals include one or more beams that form the codebook.

Some implementations of the methods and apparatuses described herein may further include receiving, at a first apparatus, a notification including codebook configuration including codebook boundaries and a number of positioning reference signal beams for forming a codebook of the first apparatus; generating a codebook based at least in part on the codebook configuration; and transmitting, to a second apparatus and based at least in part on the codebook, beams that include positioning reference signals.

Some implementations of the methods and apparatuses described herein may further include: where the beams that include the positioning reference signals include one or more beams that form the codebook.

### BRIEF DESCRIPTION OF THE DRAWINGS

FIG. 1 illustrates an example of a wireless communications system that supports codebook configuration for device positioning in accordance with aspects of the present disclosure.

FIG. 2 illustrates a system that can transmit PRS.

FIG. 3 illustrates a system that provides an overview of absolute and relative positioning scenarios.

FIG. 4 illustrates a scenario that supports codebook configuration for device positioning in accordance with aspects of the present disclosure.

FIG. 5 illustrates a scenario that supports codebook configuration for device positioning in accordance with aspects of the present disclosure.

FIGS. 6 and 7 illustrate systems that support codebook configuration for device positioning in accordance with aspects of the present disclosure.

FIGS. 8 and 9 illustrate examples of block diagrams of devices that support codebook configuration for device positioning in accordance with aspects of the present disclosure.

FIGS. 10 through 14 illustrate flowcharts of methods that support codebook configuration for device positioning in accordance with aspects of the present disclosure.

### DETAILED DESCRIPTION

In wireless communications systems, positioning accuracy specifications can be defined based on applications and use cases, where non-critical scenarios may specify relaxed specifications compared to critical scenarios. For instance, relaxing the positioning accuracy specifications can reduce the usage of system resources (e.g., time, frequency, power, etc.) as well as the computational complexity. On the other hand, positioning estimation accuracy can be dependent on the estimation accuracy of position-related parameters (e.g., ToA, AoA, and AoD), where position-related parameter estimation accuracy can be based on multiple factors including a codebook utilized by a node, e.g., an anchor node, a target UE node, etc. A codebook, for example, can be utilized for various purposes such as to estimate the position-related parameters from the received PRS, sidelink positioning reference signal (SL-PRS), or sounding reference signal (SRS) CIR measurements using a codebook-based method, and transmit and/or receive PRS, SL-PRS, or SRS signals using codebook beams. In implementations, an estimation accuracy, complexity, and delay of codebook-based methods can be based on a number of the codewords and/or beams forming the codebook, where a larger number of codewords and/or beams may provide better estimation accuracy, but in the expense of higher computational complexity and/or delay, and vice versa.

Further, to maintain a certain positioning accuracy, the estimation accuracy of the position-related parameters may be increased as the distance between the anchor node and the target UE increases. Therefore, there is a benefit and a need to adaptively adjust the estimation accuracy of the position-related parameters depending on e.g., the desired positioning accuracy (e.g., based on application and/or use-case), energy-consumption limits of the estimating node, maximum delay and latency, mobility status of anchors and target UE, as well as the distance between the anchor nodes and the target UE. This can be done by various methods, e.g., by adjusting the system resources (e.g., time, frequency, power) and/or by adjusting the number of the codebook codewords/beams.

Accordingly, this disclosure provides for techniques that support codebook configuration for device positioning. For instance, implementations provide for codebook configuration based on various criteria pertaining to network configuration entities (e.g., a location and mobility function (LMF)), target UE nodes (e.g., UEs for which position is to be determined) and/or positioning anchor nodes, e.g., nodes that transmit PRS. The criteria, for example, represent attributes of the different nodes that may affect codebook configuration and/or complexity. Using a configured codebook, a target UE can process received PRS to determine different position-related parameters of the target UE. The target UE can transmit the position-related parameters to a different node (e.g., a network entity) to enable the different node to process the position-related parameters to estimate a location of the target UE.

By utilizing the described techniques, codebook configuration for position determination can be dynamically adapted to different device attributes and/or scenarios, such as to increase position determination accuracy and to reduce burden on system resources (e.g., power, processing, data transmission, etc.) as part of position estimation.

Aspects of the present disclosure are described in the context of a wireless communications system. Aspects of the present disclosure are further illustrated and described with reference to device diagrams and flowcharts.

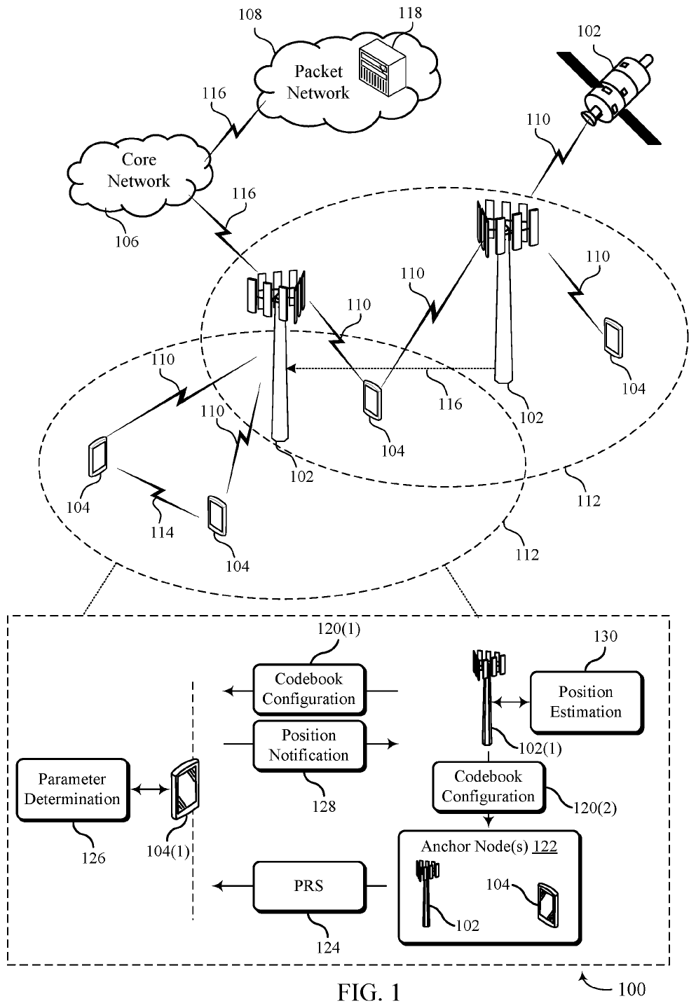

FIG. 1 illustrates an example of a wireless communications system 100 that supports codebook configuration for device positioning in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, media access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=³) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for codebook configuration for device positioning, a network entity 102(1) can generate a codebook configuration 120(1) and transmit the codebook configuration 120(1) to a UE 104(1) (e.g., a target UE), and can generate a codebook configuration 120(2) and transmit the codebook configuration 120(2) to one or more anchor nodes 122. As detailed below, the codebook configurations 120(1), 120(2) can be generated based on various criteria, such as attributes of the UE 104(1), the one or more anchor nodes 122, and/or the network entity 102(1). Further, the one or more anchor nodes 122 transmit PRS to the UE 104(1). In at least one implementation, the one or more anchor nodes 122 transmit the PRS 124 based at least in part on the codebook configuration 120(2), such as based on beam attributes defined using by a codebook generated based on the codebook configuration 120(2).

The UE 104(1) then performs parameter determination 126 based on the PRS 124. For instance, the UE 104(1) generates a codebook based on the codebook configuration 120(1) and utilizes the codebook to process the PRS 124 to perform the parameter determination 126. Accordingly, based on the parameter determination 126, the UE 104(1) generates a position notification 128 that includes different position-related parameters, examples of which are detailed below. The UE 104(1) transmits the position notification 128 to the network entity 102(1), which utilizes position-related parameters from the position notification 128 to perform position estimation 130 to estimate a position of the UE 104(1).

In some wireless communications systems, NR positioning based on NR Uu signals and standalone (SA) architecture (e.g., beam-based transmissions) are specified such as specified in Rel-16. The targeted use cases include commercial and regulatory (emergency services) scenarios such as in Rel-15. The performance requirements include the following:

| Positioning Error | Indoor | Outdoor |
|---|---|---|
| Horizontal | <3 m for 80% of UEs | <10 m for 80% of UEs |
| Positioning | | |
| Vertical Positioning | <3 m for 80% of UEs | <3 m for 80% of UEs |

Current 3GPP Rel-17 Positioning has recently defined the positioning performance requirements for Commercial and IIoT use cases as follows:

| Positioning Error | Commercial | IIoT |
|---|---|---|
| Horizontal Positioning | (<1 m) for 90% | (<0.2 m) for 90% |
| | of UEs | of UEs; |
| Vertical Positioning | (<3 m) for 90% | (<1 m) for 90% |
| | of UEs | of UEs |
| Physical layer latency | (<10 ms) | (<10 ms) |
| for position estimation | | |
| of UE | | |
| End-to-End Latency | (<100 ms) | (<100 ms, in the order |
| for position estimation | | of 10 ms is desired) |
| of UE | | |

Examples of supported positioning techniques in Rel-16 are listed in Table 1:

TABLE 1
Supported Rel-16 UE positioning methods

| | | UE- | NG-RAN | |
|---|---|---|---|---|
| | UE- | assisted, | node | |
| Method | based | LMF-based | assisted | SUPL |
| A-GNSS | Yes | Yes | No | Yes (UE-based |
| | | | | and UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{NOTE 1}:
This includes transport block size (TBS) positioning based on PRS signals.
^{NOTE 2}:
In this version of the specification only observed time difference of arrival (OTDOA) based on LTE signals is supported.
^{NOTE 4}:
This includes Cell-ID (CID) and/or extended-CID (E-CID) for NR method.
^{NOTE 5}:
In this version of the specification only for TBS positioning based on multicast and broadcast services (MBS) signals.

According to different wireless positioning scenarios, separate positioning techniques as indicated in Table 1 can be currently configured and performed based on the requirements of a location management function (LMFII) and UE capabilities. The transmission of Uu (uplink and downlink) PRS enable the UE to perform UE positioning-related measurements to enable the computation of a UE's absolute location estimate and are configured per Transmission Reception Point (TRP), where a TRP may include a set of one or more beams.

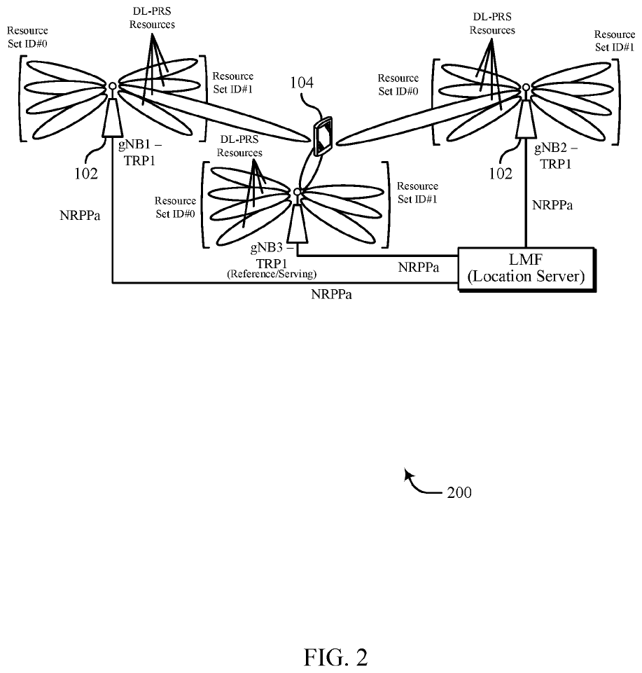

FIG. 2 illustrates a system 200 that can transmit PRS. The system 200, for instance, illustrates that according to Rel-16, the PRS can be transmitted by different base stations (serving and neighboring) using narrow beams over FR1 and FR2, which is relatively different when compared to LTE where the PRS was transmitted across the whole cell. The PRS can be locally associated with a PRS Resource identifier (ID) and Resource Set ID for a base station (TRP). Similarly, UE positioning measurements such as Reference Signal Time Difference (RSTD) and PRS reference signal received power (RSRP) measurements are made between beams (e.g., between a different pair of downlink (DL) PRS resources or DL PRS resource sets) as opposed to different cells as was the case in LTE. In addition, there are additional uplink (UL) positioning methods for the network to exploit in order to compute the target UE's location. RAT-dependent positioning techniques involve the 3GPP RAT and core network entities to perform the position estimation of the UE, which are differentiated from RAT-independent positioning techniques which rely on global navigation satellite systems (GNSS), inertial measurement unit (IMU) sensor, wireless local access network (WLAN) and Bluetooth technologies for performing target device (e.g., target UE) positioning.

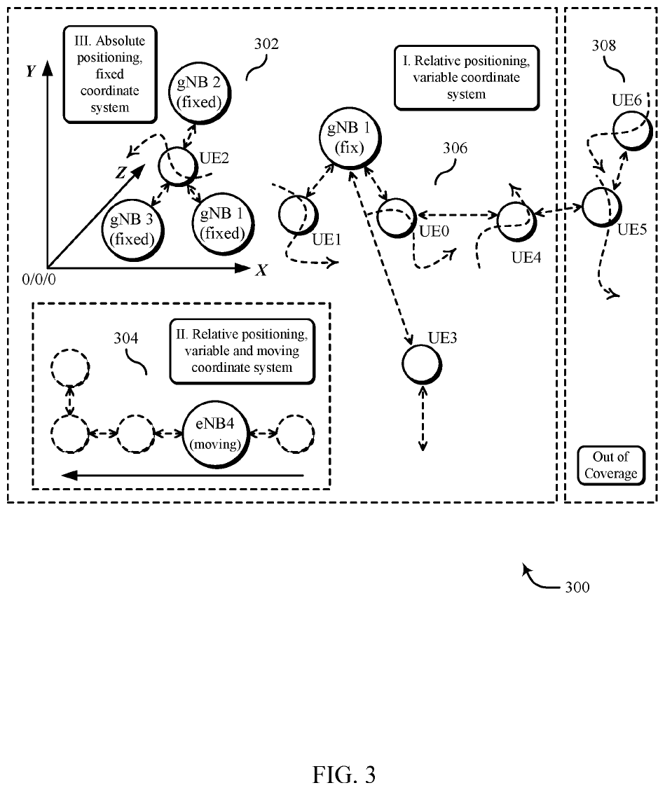

FIG. 3 illustrates a system 300 that provides an overview of absolute and relative positioning scenarios. The system 300, for instance, is defined in a system architecture using three different coordinate systems.
Absolute Positioning, fixed coordinate systems
Relative Positioning, variable and moving coordinate system
Relative Positioning, variable coordinate system

The following terms may be used within this disclosure and the following represents some example non-limiting explanations for these terms:
Target UE may be referred to as a UE of interest whose position (absolute or relative) is to be obtained by a network or by the UE itself.
Sidelink positioning: Positioning UE using reference signals transmitted over sidelink (SL) (e.g., PC5 interface) to obtain absolute position, relative position, and/or ranging information.
Ranging: determination of a distance and/or a direction between a UE and another entity, e.g., an anchor UE.
Anchor UE: UE supporting positioning of a target UE, e.g., by transmitting and/or receiving reference signals for positioning, providing positioning-related information, etc., such as over a sidelink interface.
SL positioning node may refer to a network entity and/or device (e.g., a UE) participating in a SL positioning session, and may be implemented as an LMF (location server), gNB, UE, roadside unit (RSU), anchor UE, initiator and/or responder UE, etc.
SL PRS (pre-)configuration: (pre-)configured parameters of SL PRS such as time-frequency resources (other parameters are not precluded) including its bandwidth and periodicity.

Accordingly, solutions are provided in this disclosure to support codebook configuration for device positioning in accordance with various implementations. The described solutions, for example, provide dynamic codebook configuration for position determination for adapting codebooks to different device attributes and/or scenarios, such as to increase position determination accuracy and to reduce burden on system resources (e.g., power, processing, data transmission, etc.) as part of position estimation.

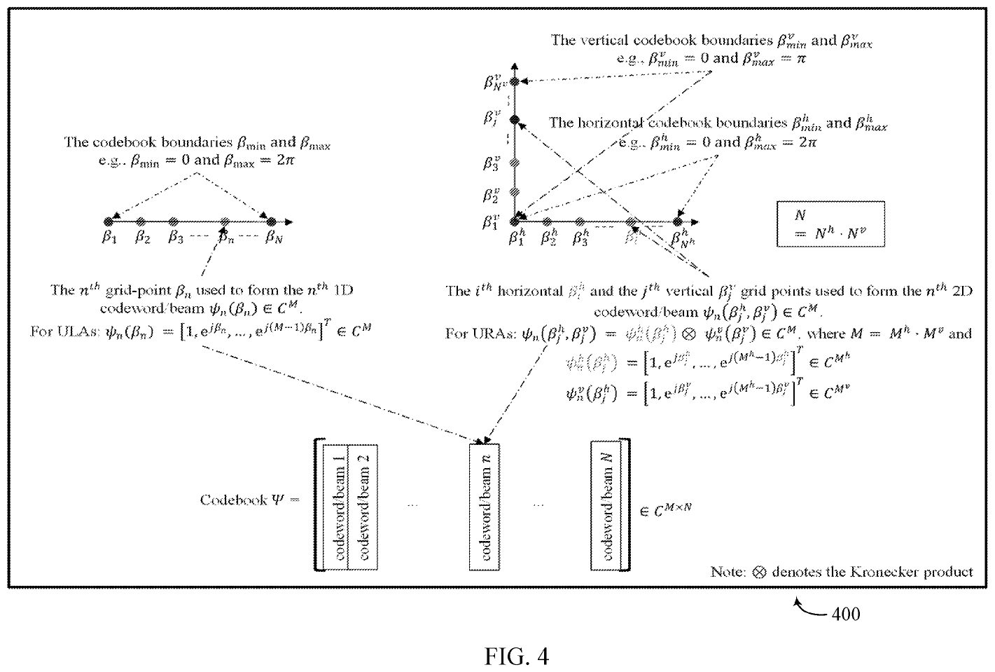

FIG. 4 illustrates a scenario 400 that supports codebook configuration for device positioning in accordance with aspects of the present disclosure. The scenario 400, for example, presents details for utilizing angular resolution as part of position determination.

The scenario 400 includes a codebook 402 which can be characterized using several parameters, including:
1. A codebook dimensionality xD, x∈{1, 2, 3, . . . }, which can be specified based on various factors such as node capability (e.g., user location accuracy (ULA), user range accuracy (URA) and/or CIR measurements dimensionality) where in implementations, the CIR measurements can be represented/reshaped into an x-way tensor, x∈{1, 2, 3, . . . };
2. Codebook grid boundaries 404, e.g., βₘᵢₙ and βₘₐₓ in a 1D case, which can set minimum and maximum limits on the grid points, i.e., βₙ∈[βₘᵢₙ, βₘₐₓ];
3. A number of grid points N used to form the codebook 402 codewords and/or beams;
4. A sampling method of the area spanned by the codebook grid boundaries 404. For example, in the 1D case, the grid points βₙ∈[βₘᵢₙ, βₘₐₓ] can either be selected so that they uniformly sample the area spanned by the codebook boundaries βₘᵢₙ and βₘₐₓ (e.g., as βₙ=βₘᵢₙ+n·(βₘₐₓ−βₘᵢₙ)/(N−1), with n∈{0, . . . , N−1}) or non-uniformly based on implementation details;
5. A codeword dimension M, which can be specified such as based on the node capability. For instance, M represents a total number of antenna elements of a node in the horizontal axis and the vertical axis;
6. The codebook-resolution βᵣₑₛ, which can be defined as the minimum distance between two adjacent grid points. Note that, a fine-resolution codebook can be obtained by increasing the number of codewords N and/or narrowing the distance between the codebook boundaries βₘᵢₙ and βₘₐₓ.

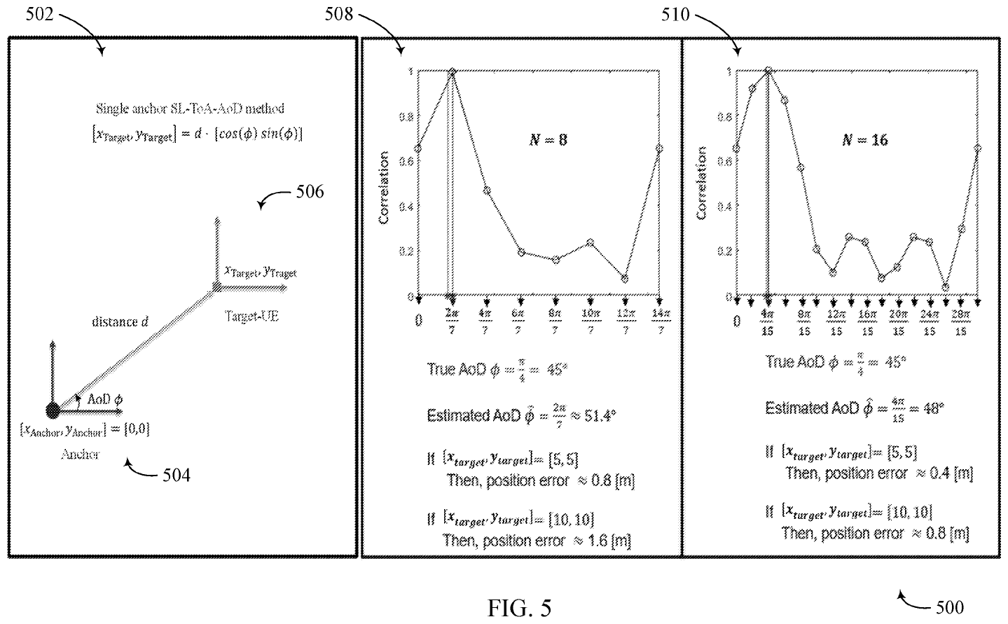

FIG. 5 illustrates a scenario 500 that supports codebook configuration for device positioning in accordance with aspects of the present disclosure. The scenario 500, for example, illustrates the impact of a number of codewords N on the estimation accuracy of a position-related parameter. Moreover, it is shown that the positioning error can double when the distance between the anchor node and the target UE is doubled.

According to implementations, a codebook can be used for various purposes. For instance, a codebook can be used to estimate position-related parameters from received CIR measurements using a codebook-based method, e.g., a simple correlation-based method and/or MUSIC.

Consider, for example, the scenario 502 shown within the scenario 500, where an anchor node 504 equipped with a ULA of M=4 antennas and transmitting a PRS signal to a Target UE 506 having a single antenna. According to implementations, it can be assumed that a pure line of sight (LOS) channel exists between the anchor node 504 and the Target UE 506. The CIR measurements at the Target UE 506, such as in a noiseless case, can be expressed as:

$$y = hs ∈ {C}^{M} ,$$

where h=α·ψ(φ)∈C^{M} is the channel vector, in which ψ(φ)=[1, . . . , e^{j(M-1)φ}]^{T}∈C^{M} represents the true steering (response) vector at the anchor node 504, φ∈[0, 2π] is the true AoD, α is the channel path gain, and s is the transmitted PRS symbol. According to implementations, it can be assumed that s=1 and α=1, such as without loss of generality. Given the measurement vector y and a codebook with N codewords as Ψ=[ψ₁(β₁), . . . , ψ_{N}(β_{N})]∈C^{M×N}, the Target UE can estimate the AoD φ using a simple correlation-based method as:

$$\hat{ϕ} = {argmax}_{{β}_{n}} \frac{\vert {y}^{H} {ψ}_{n} ( {β}_{n} ) \vert}{‖ y ‖ \cdot ‖ {ψ}_{n} ( {β}_{n} ) ‖} ,$$

where ψₙ(βₙ)∈C^{M} is the n^{th} codeword. Assuming that βₘᵢₙ=0, βₘₐₓ=2π, the n^{th} grid point can be selected as

$${β}_{n} = {β}_{min} + n \cdot \frac{{β}_{max} - {β}_{min}}{N - 1} = n \cdot \frac{2 π}{N - 1} ∈ [ 0 , 2 π ] ,$$

n∈{0, . . . , N−1}.

The scenario 500 also shows the correlation function versus the codebook codewords and/or grid points for two different number of codewords N∈{8, 16} at 508, 510, respectively. As is illustrated, increasing the number of codewords N from 8 to 16 increases the estimation accuracy of the AoD, since it improves the codebook resolution from 2π/7 to 2π/15. Moreover, it can be seen that the positioning error doubles when the position of the Target UE 506 is moved from [x_{target}, y_{target}]=[5, 5] to [x_{target}, y_{target}]=[10, 10], which doubles the distance between the anchor node and the Target UE, but keeps the AoD the same as φ=π/4=45°. Therefore, for example, if the positioning error is to be maintained such as when the distance is doubled, the AoD estimation error is to be decreased by half, such as depicted at 508, 510.

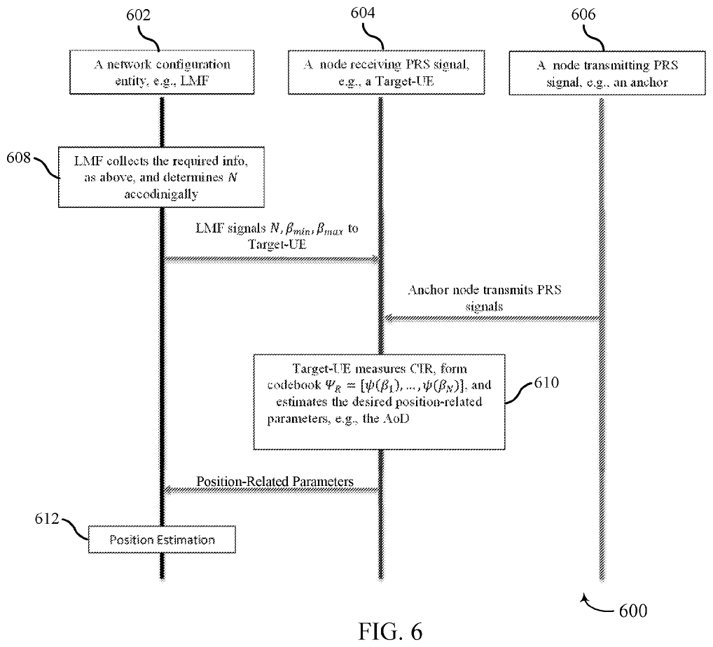

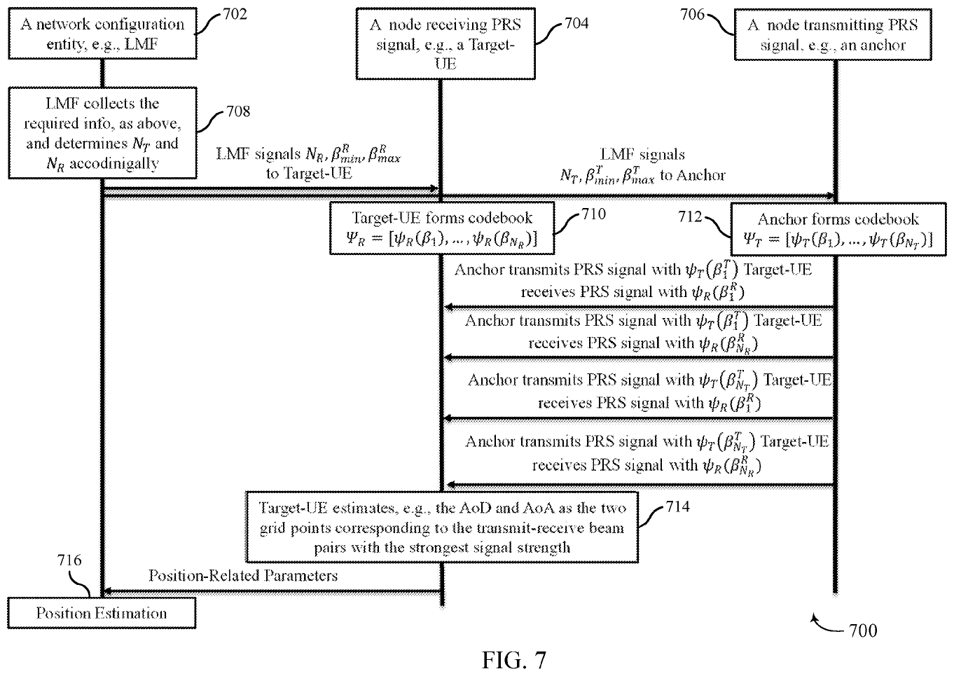

FIG. 6 illustrates a system 600 and FIG. 7 illustrates a system 700 that support codebook configuration for device positioning in accordance with aspects of the present disclosure. The systems 600, 700, for example, illustrate implementations for signalling a number of codewords and/or beams between nodes such as network entities and UEs.

The system 600 includes a network configuration entity 602 (e.g., an LMF), a receiving node 604 (e.g., a target UE), and a transmitting node 606, e.g., an anchor node. In the system 600, the network configuration entity 602 at 608 determines N, such as based on various criteria discussed herein. The network configuration entity 602 transmits N, β_min, β_max to the receiving node 604. Further, the transmitting node 606 transmits PRS to the receiving node 604. The receiving node 604 at 610 performs measurements on the PRS, generates a codebook based on N, β_min, β_max, and estimates position-related parameters such as AoD. The receiving node 604 can then transmit the estimated position-related parameters to the network configuration entity 602 which at 612 can perform position estimation of the receiving node 604 based at least in part on the position-related parameters.

The system 700 includes a network configuration entity 702 (e.g., an LMF), a receiving node 704 (e.g., a target UE), and a transmitting node 706, e.g., an anchor node. In the system 700, the network configuration entity 702 at 708 determines N_{T} and N_{R} such as based on various criteria discussed herein. The network configuration entity 702 transmits N_{R}, β^{R}_min, β^{R}_max to the receiving node 704. Further, the network configuration entity 702 transmits N_{T}, β^{T}_min, β^{T}_max to the transmitting node 706. At 710 the receiving node 704 generates a codebook based on N_{R}, β^{R}_min, β^{R}_max and at 712 the transmitting node 706 generates a codebook based on N_{T}, β^{T}_min, β^{T}_max.

Further to the system 700, the respective codebooks can be used to transmit and receive positioning signals (e.g., PRS, SL-PRS, SRS, etc.) using the codebook beams. For instance, as illustrated in the system 700, the anchor node 706 (e.g., gNB, RSU, TRP) can be configured to transmit PRS signals using its codebook transmit N_{T} beams, while the receiving node 704 can be configured to measure the signal strength using its codebook receive N_{R} beams. At 714 the receiving node 704 performs measurements on the PRS, and estimates position-related parameters such as AoD based on its codebook. An angle of departure (AOD) and angle of arrival (AOA), for example, can be estimated as two grid points corresponding to the transmit-receive beam pairs with a strongest signal strength. In implementations, N_{T} and N_{R} can be the same as N such as in the scenario 400, and the subscripts _{⋅T} and _{⋅R} are used to differentiate between transmit beams and receive beams.

Further to the system 700 the receiving node 704 can then transmit the estimated position-related parameters to the network configuration entity 702 which at 716 can perform position estimation of the receiving node 704 based at least in part on the position-related parameters.

In implementations, the systems 600, 700, can be implemented to dynamically adapt to changes in criteria that may affect codebook configuration, such as changes in device attributes, e.g., attributes of a target UE and/or an anchor device. For instance, after configuration of codebook parameters such as N and β values such as described above in the systems 600, 700, a network configuration entity 602, 702 can detected a change in criteria that may affect codebook configuration. Accordingly, in response to detecting the change in codebook criteria, a network configuration entity 602, 702 can generate updated values for one or more of N, N_{T}, N_{R}, β_min, β_max, β^{T}_min, β^{T}_max, β^{R}_min, or β^{R}_max. The updates values can be communicated to a target UE and/or an anchor node and utilized by the target UE and/or the anchor node to generate an updated codebook for receiving, transmitting, and/or processing positioning reference signals. Thus, the systems 600, 700 can be implemented to initially configure codebook features and to update codebook features based on changes in codebook criteria. Accordingly, a codebook configuration can be dynamically adjusted based on a change in the one or more criteria. Examples of different criteria that may affect codebook configuration are discussed below.

In implementations, a network device configuration entity (e.g., LMF and/or an anchor node) can determine the number of the codewords and/or beams N forming a codebook considering one or more criteria. Examples of different criteria include:
1. A positioning estimation accuracy specification (e.g., requirement):
   a. A larger N can be specified for a higher (e.g., stricter) positioning accuracy specification, and a smaller N can be specified for a lower positioning accuracy specification;
      i. In implementations, a larger N can result in a fine-resolution codebook and thus a fine estimation accuracy, while a smaller N can result in a coarse-resolution codebook and thus a coarse estimation accuracy;
      ii. In implementations, depending on a node capability, the positioning accuracy may comprise horizontal and/or vertical accuracy. In such scenarios, the total number of codewords and/or beams N can be divided between the horizontal and/or the vertical accuracy as N=N^{h}·N^{v}, where N^{h} denotes the number of codewords and/or beams in the horizontal dimension, and N^{v} denotes the number of codewords and/or beams in the vertical dimension, such as illustrated in FIG. 4.
2. A distance between a target UE and anchor node(s):
   a. A larger N can be specified for longer distance, and a smaller N can be specified for a smaller distance;
      i. In implementations, such as illustrated in FIG. 5, if a certain positioning accuracy is specified to be maintained, then the estimation accuracy of the position-related parameters is to be increased with increasing distance between the anchor node and the target UE;
      ii. In implementations, if the target UE has a different distance to every anchor node of a set of anchor nodes, a different N can be selected for every anchor node of the set of anchor nodes;
      iii. In implementations, if the distance is not available explicitly (e.g., via ranging), a pathloss can be used to approximate it and/or by using other metrics that are part of a function of the distance, such as received signal strength indicator (RSSI).
3. A latency and/or delay specification:
   a. A smaller N for a shorter latency and/or delay specification, and a larger N for a longer latency and/or delay specification;
      i. In implementations, a node may require N time symbols to transmit and/or receive PRS signals via N beams, which can increase the delay of position estimation, and vice-versa.
4. An energy-consumption of a node:
   a. A smaller N can be specified for energy-limited nodes, e.g., mobile phones, and a larger N can be specified for nodes with larger power resources;
      i. In implementations, increasing a number of beams N can increase the transmit and/or receive energy-consumption, and decreasing a number of beams N can decrease the transmit and/or receive energy-consumption.
5. A node mobility status:
   a. A smaller N can be specified for higher mobility nodes, and a larger N can be specified for lower mobility nodes, e.g., stationary and/or fixed position nodes;
      i. In implementations, a higher node mobility can decrease a channel coherence-time, which can limit position estimation accuracy. Therefore, reducing the number of codewords and/or beams N can provide a coarse estimation accuracy.
6. The codebook boundaries βₘᵢₙ and βₘₐₓ.
   a. A smaller N can be specified for a narrower distance between the codebook boundaries βₘᵢₙ and βₘₐₓ, and a larger N can be specified for a wider distance between the codebook boundaries βₘᵢₙ and βₘₐₓ;
      i. In implementations, to maintain a certain codebook-resolution, the number of codewords N can be increased while keeping the codebook boundaries βₘᵢₙ and βₘₐₓ fixed, or decreased while keeping the codebook boundaries βₘᵢₙ and βₘₐₓ fixed, e.g., by narrowing the distance between the codebook boundaries βₘᵢₙ and βₘₐₓ, while keeping the number of codewords N fixed.
7. A PRS time-frequency resource configuration, e.g., a number of time symbols and/or the number of frequency sub-carriers (e.g., bandwidth, which can be characterized as a number of resource-blocks (RBs)):
   a. A larger N can be specified for a larger number of time symbols and/or a larger number of frequency sub-carriers (RBs), and a smaller N can be specified for a smaller number of time symbols and/or a smaller number of frequency sub-carriers (RBs);
      i. In implementations, in beam-based positioning methods, a node can be configured to transmit and/or receive in T time symbols and K sub-carriers (e.g., RBs). Therefore, a network configuration entity can determine the number of codebook beams as N=TK, e.g., a different beam is used to transmit and/or receive in every time symbol and/or sub-carrier, or as N<TK, where one or more beams are repeated in the signal transmission and/or reception.

In implementations, a number of the codewords and/or beams N can be determined by a network device configuration entity, e.g., an LMF entity and/or an anchor node, e.g., gNB, RSU, TRP, a vehicle-UE, etc. In implementations, the number of the codewords and/or beams N can be signalled to a network node, e.g., an anchor node and/or a Target UE receiving and/or transmitting PRS, SL-PRS, or SRS signals, such as illustrated in the systems 600, 700.

In implementations, the configuration entity (e.g., LMF) can determine the number of codewords and/or beams for each dimension (e.g., the number of horizontal codewords and/or beams N^{h} and the number of vertical codewords and/or beams N^{v}) assuming preconfigured codebook boundaries, e.g., preconfigured horizontal boundaries

$${β}_{min}^{h} and {β}_{max}^{h}$$

and/or preconfigured vertical boundaries

$${β}_{min}^{v} and {β}_{max}^{v} .$$

In such scenarios, the configuration entity can signal the number of codewords and/or beams for each dimension, e.g., N^{h} and N^{v}.

In implementations, the configuration entity (e.g., LMF) can determine the number of the codewords and/or beams for each dimension (e.g., the number of horizontal codewords and/or beams N^{h} and the number vertical codewords and/or beams N^{v}) assuming updated codebook boundaries (e.g., updated horizontal boundaries

$${β}_{min}^{h} and {β}_{max}^{h}$$

and/or updated vertical boundaries

$$( {β}_{min}^{v} and {β}_{max}^{v} )$$

based on, for example, a pre-estimated position-related parameter. In such scenarios, the configuration entity can signal the horizontal codebook boundaries

$$( {β}_{min}^{h} and {β}_{max}^{h} )$$

and/or the vertical codebook boundaries

$$( {β}_{min}^{v} and {β}_{max}^{v} )$$

along the number of the horizontal codewords and/or beams N^{h} and/or the number of the vertical codewords and/or beams N^{h}.

In implementations, aspects such as the positioning accuracy, latency requirement, and energy consumption may be specified by a location service (LCS) client (internal and/or external) via a positioning QoS. The accuracy may further include horizontal and/or vertical accuracy.

In implementations, a relative distance between an anchor node(s) and a target UE may be initially established using methods such as: coarse positioning techniques such as received signal strength (RSS)-based measurement fingerprinting, DL and/or SL pathloss estimates, relative distance derived on Zone IDs, etc.

In implementations, a configuration entity and/or node may configure a transmit and/or measurement codebook based on a DL and/or SL configuration. In scenarios for a DL configuration, an LMF may transmit such a codebook request to serving and neighbouring gNBs and/or TRPs (e.g., NG-RAN nodes) and subsequently receive a response containing the codebook or lack thereof, which in implementations can be signalled using the NRPPa interface. In scenarios using a SL configuration, the configuration entity based on the scenario (e.g., in-coverage, partial coverage, or out-of-coverage), may signal the transmit and/or measurement codebook using PC5 signalling, e.g., SL positioning (e.g., ranging sidelink) sidelink protocol, PC5 RRC, PC5-S, SL MAC control element (CE) signalling, etc.

In implementations, the mobility status (e.g., low, medium, high) may influence the frequency with which the codebook may be updated from coarse to fine resolution (or vice versa) based on mobility status feedback received from the target UE. The frequency, for instance, may be expressed in terms of configured periodicity of signalling the configuration.

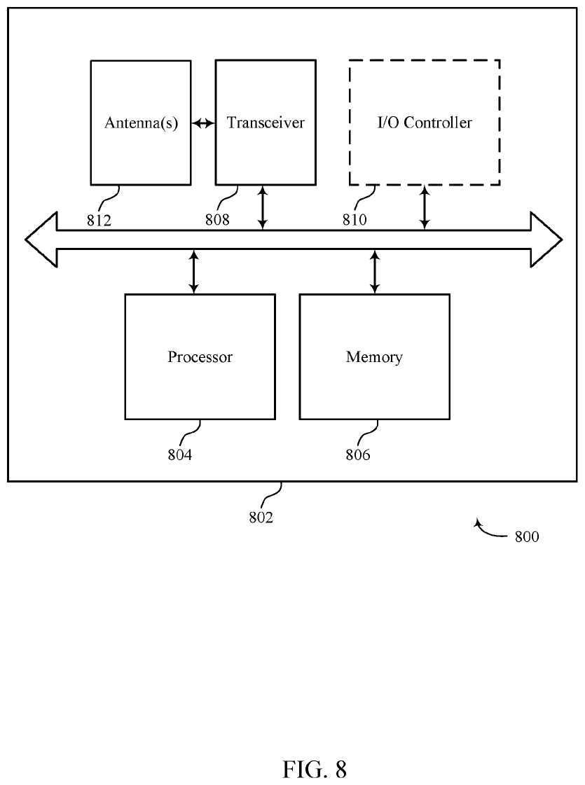

FIG. 8 illustrates an example of a block diagram 800 of a device 802 (e.g., an apparatus) that supports codebook configuration for device positioning in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, memory 806, the transceiver 808, or various combinations thereof or various components thereof may be examples of means for performing various aspects of the present disclosure as described herein. For example, the processor 804, memory 806, the transceiver 808, or various combinations or components thereof may support a method for performing one or more of the operations described herein.

In some implementations, the processor 804, memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and memory 806 coupled with the processor 804 may be configured to perform one or more of the functions described herein (e.g., executing, by the processor 804, instructions stored in memory 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as and/or otherwise support a means to receive a notification including codebook configuration including codebook boundaries and a number of positioning reference signal features for forming a codebook of the first apparatus; generate a codebook based at least in part on the codebook configuration; receive positioning reference signals; generate positioning measurements based at least in part on the positioning reference signals and the codebook; and transmit the positioning measurements to a second apparatus.

Further, in some implementations, the positioning reference signal features include one or more of a number of positioning reference signal codewords per dimension or a number of positioning reference signal beams per dimension; to generate the positioning measurements the processor is configured to use codewords forming the codebook to process the positioning reference signals; the processor is further configured to process one or more paths of CIR to generate the positioning measurements; the processor is configured to generate the positioning measurements using one or more codebook-based methods; the one or more codebook-based methods include MUSIC; the processor is configured to generate the positioning measurements based at least in part on one or more of uplink, downlink, or sidelink positioning measurements; the first apparatus includes a UE, and the second apparatus includes one or more of an apparatus that transmits the notification or an apparatus that transmits the positioning reference signals.

In a further example, the processor 804 and/or the transceiver 808 may support wireless communication at the device 802 in accordance with examples as disclosed herein. The processor 804 and/or the transceiver 808, for instance, may be configured as or otherwise support a means to receive a notification including codebook configuration including codebook boundaries and a number of positioning reference signal beams for forming a codebook of the first apparatus; generate a codebook based at least in part on the codebook configuration; receive beams that include positioning reference signals; generate positioning measurements based at least in part on one or more positioning reference signals from one or more beams with a strongest signal strength and the codebook; and transmit the positioning measurements to a second apparatus.

Further, in some implementations, the beams that include the positioning reference signals include one or more beams that form the codebook.

The processor 804 of the device 802, such as a UE 104, may support wireless communication in accordance with examples as disclosed herein. The processor 804 includes at least one controller coupled with at least one memory and is configured to or operable to cause the processor to perform the various operations described with reference to the device 802, such as a UE 104. For instance, the processor is configured to and/or operable to receive a notification comprising codebook configuration including codebook boundaries and a number of positioning reference signal features for forming a codebook of a UE; generate a codebook based at least in part on the codebook configuration; receive positioning reference signals; generate positioning measurements based at least in part on the positioning reference signals and the codebook; and transmit the positioning measurements to an apparatus.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., memory 806) to cause the device 802 to perform various functions of the present disclosure.

Memory 806 may include random access memory (RAM) and read-only memory (ROM). Memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device 802. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

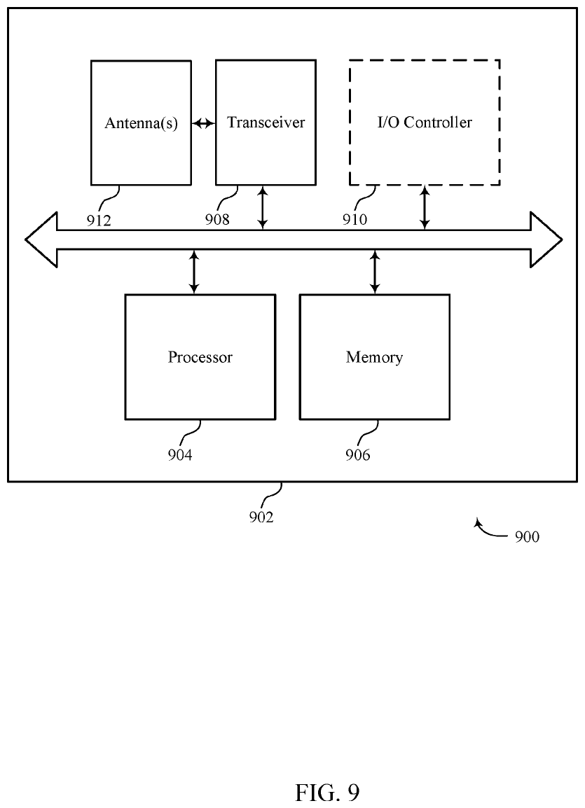

FIG. 9 illustrates an example of a block diagram 900 of a device 902 (e.g., an apparatus) that supports codebook configuration for device positioning in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of network entity 102, for example, the transceiver 908 and the processor 904 coupled to the transceiver 908 are configured to cause the network entity 102 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as or otherwise support a means to generate a notification including codebook configuration including codebook boundaries and a number of positioning reference signal features for forming a codebook of a second apparatus, the number of positioning reference signal features based at least in part on one or more criteria; transmit the notification to the second apparatus; receive positioning measurements generated by the second apparatus based at least in part on the codebook configuration; and generate a position estimate of the second apparatus based at least in part on the positioning measurements.

Further, in some implementations, the positioning reference signal features include one or more of a number of positioning reference signal codewords per dimension or a number of positioning reference signal beams per dimension; the one or more criteria include one or more of: one or more capabilities of the second apparatus; one or more positioning accuracy features of the first apparatus; a power usage parameter of the second apparatus; a maximum delay parameter of the first apparatus; a mobility status of the second apparatus; the codebook boundaries of the second apparatus; or a positioning reference signal time-frequency resource configuration of the second apparatus; the processor is further configured to transmit positioning reference signals to the second apparatus; the processor is configured to generate the position estimate of the second apparatus as one or more of: an absolute position of the second apparatus; a relative position of the second apparatus; or a range estimate including of one or more of a distance or a relative direction with respect to one or more of the first apparatus or an apparatus that transmits positioning reference signals to the second apparatus; the positioning measurements are based at least in part on one or more of uplink, downlink, or sidelink positioning measurements; the first apparatus includes a network configuration entity and the second apparatus includes a UE; the processor is further configured to: receive an indication of a change in the one or more criteria; and dynamically adjust the codebook configuration based on the change in the one or more criteria.

In a further example, the processor 904 and/or the transceiver 908 may support wireless communication at the device 902 in accordance with examples as disclosed herein. The processor 904 and/or the transceiver 908, for instance, may be configured as or otherwise support a means to generate a first notification including a codebook configuration of a second apparatus including codebook boundaries and a number of positioning reference signal beams for forming a codebook of the second apparatus, the number of positioning reference signal beams based at least in part on a first set of criteria; generate a second notification including a codebook configuration of one or more third apparatus including codebook boundaries and a number of positioning reference signal beams for forming a codebook of the one or more third apparatus, the number of positioning reference signal beams based at least in part on a second set of criteria; transmit the first notification to the second apparatus, and the second notification to the one or more third apparatus; receive positioning measurements generated by the second apparatus based at least in part on the codebook configuration of the second apparatus; and generate a position estimate of the second apparatus based at least in part on the positioning measurements.

Further, in some implementations, one or more of the first set of criteria or the second set of criteria include one or more of: at least one of one or more capabilities of the second apparatus or one or more capabilities of the one or more third apparatus; one or more positioning accuracy features of the first apparatus; one or more of a power usage parameter of the second apparatus or a power usage parameter of the one or more third apparatus; a maximum delay parameter of the first apparatus; one or more of a mobility status of the second apparatus or a mobility status of the one or more third apparatus; one or more of the codebook boundaries of the second apparatus or the codebook boundaries of the one or more third apparatus; or one or more of a positioning reference signal time-frequency resource configuration of the second apparatus or a positioning reference signal time-frequency resource configuration of the one or more third apparatus; the processor is configured to generate the position estimate of the second apparatus as one or more of: an absolute position of the second apparatus; a relative position of the second apparatus; or a range estimate including of one or more of a distance or a relative direction with respect to one or more of the first apparatus or an apparatus that transmits positioning reference signals to the second apparatus; the positioning measurements are based at least in part on one or more of uplink, downlink, or sidelink positioning measurements; the first apparatus includes a network configuration entity, the second apparatus includes a UE, and the one or more third apparatus includes one or more apparatus that transmits positioning reference signals to the second apparatus.

In a further example, the processor 904 and/or the transceiver 908 may support wireless communication at the device 902 in accordance with examples as disclosed herein. The processor 904 and/or the transceiver 908, for instance, may be configured as or otherwise support a means to receive a notification including codebook configuration including codebook boundaries and a number of positioning reference signal beams for forming a codebook of the first apparatus; generate a codebook based at least in part on the codebook configuration; and transmit, to a second apparatus and based at least in part on the codebook, beams that include positioning reference signals.

Further, in some implementations, the beams that include the positioning reference signals include one or more beams that form the codebook.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

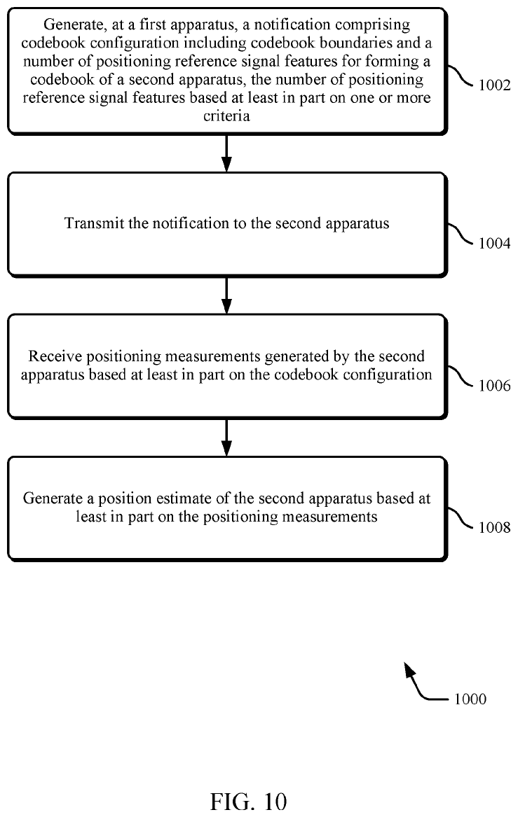

FIG. 10 illustrates a flowchart of a method 1000 that supports codebook configuration for device positioning in accordance with aspects of the present disclosure. The operations of the method 1000 may be implemented by a device or its components as described herein. For example, the operations of the method 1000 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include generating, at a first apparatus, a notification comprising codebook configuration including codebook boundaries and a number of positioning reference signal features for forming a codebook of a second apparatus, the number of positioning reference signal features based at least in part on one or more criteria. The operations of 1002 may be performed in accordance with examples as described herein. In some implementations, aspects of the operations of 1002 may be performed by a device as described with reference to FIG. 1.

At 1004, the method may include transmitting the notification to the second apparatus. The operations of 1004 may be performed in accordance with examples as described herein. In some implementations, aspects of the operations of 1004 may be performed by a device as described with reference to FIG. 1.

At 1006, the method may include receiving positioning measurements generated by the second apparatus based at least in part on the codebook configuration. The operations of 1006 may be performed in accordance with examples as described herein. In some implementations, aspects of the operations of 1006 may be performed by a device as described with reference to FIG. 1.

At 1008, the method may include generating a position estimate of the second apparatus based at least in part on the positioning measurements. The operations of 1008 may be performed in accordance with examples as described herein. In some implementations, aspects of the operations of 1008 may be performed by a device as described with reference to FIG. 1.

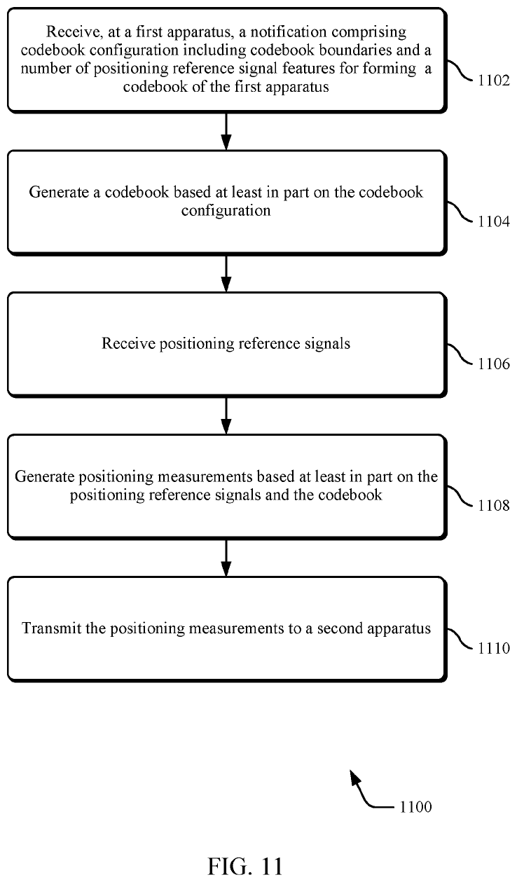

FIG. 11 illustrates a flowchart of a method 1100 that supports codebook configuration for device positioning in accordance with aspects of the present disclosure. The operations of the method 1100 may be implemented by a device or its components as described herein. For example, the operations of the method 1100 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include receiving, at a first apparatus, a notification comprising codebook configuration including codebook boundaries and a number of positioning reference signal features for forming a codebook of the first apparatus. The operations of 1102 may be performed in accordance with examples as described herein. In some implementations, aspects of the operations of 1102 may be performed by a device as described with reference to FIG. 1.

At 1104, the method may include generating a codebook based at least in part on the codebook configuration. The operations of 1104 may be performed in accordance with examples as described herein. In some implementations, aspects of the operations of 1104 may be performed by a device as described with reference to FIG. 1.

At 1106, the method may include receiving positioning reference signals. The operations of 1106 may be performed in accordance with examples as described herein. In some implementations, aspects of the operations of 1106 may be performed by a device as described with reference to FIG. 1.

At 1108, the method may include generating positioning measurements based at least in part on the positioning reference signals and the codebook. The operations of 1108 may be performed in accordance with examples as described herein. In some implementations, aspects of the operations of 1108 may be performed by a device as described with reference to FIG. 1.

At 1110, the method may include transmitting the positioning measurements to a second apparatus. The operations of 1110 may be performed in accordance with examples as described herein. In some implementations, aspects of the operations of 1110 may be performed by a device as described with reference to FIG. 1.

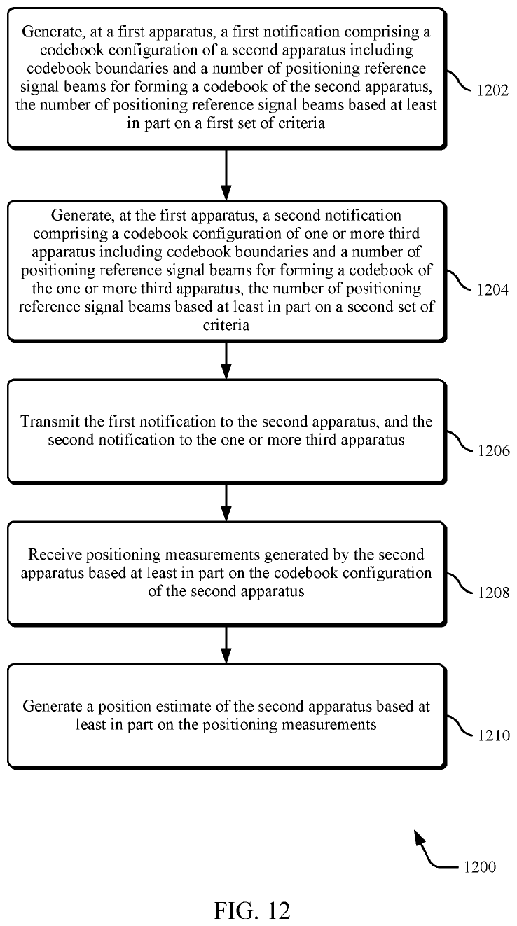

FIG. 12 illustrates a flowchart of a method 1200 that supports codebook configuration for device positioning in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include generating, at a first apparatus, a first notification comprising a codebook configuration of a second apparatus including codebook boundaries and a number of positioning reference signal beams for forming a codebook of the second apparatus, the number of positioning reference signal beams based at least in part on a first set of criteria. The operations of 1202 may be performed in accordance with examples as described herein. In some implementations, aspects of the operations of 1202 may be performed by a device as described with reference to FIG. 1.

At 1204, the method may include generating, at the first apparatus, a second notification comprising a codebook configuration of one or more third apparatus including codebook boundaries and a number of positioning reference signal beams for forming a codebook of the one or more third apparatus, the number of positioning reference signal beams based at least in part on a second set of criteria. The operations of 1204 may be performed in accordance with examples as described herein. In some implementations, aspects of the operations of 1204 may be performed by a device as described with reference to FIG. 1.

At 1206, the method may include transmitting the first notification to the second apparatus, and the second notification to the one or more third apparatus. The operations of 1206 may be performed in accordance with examples as described herein. In some implementations, aspects of the operations of 1206 may be performed by a device as described with reference to FIG. 1.

At 1208, the method may include receiving positioning measurements generated by the second apparatus based at least in part on the codebook configuration of the second apparatus. The operations of 1208 may be performed in accordance with examples as described herein. In some implementations, aspects of the operations of 1208 may be performed by a device as described with reference to FIG. 1.

At 1210, the method may include generating a position estimate of the second apparatus based at least in part on the positioning measurements. The operations of 1210 may be performed in accordance with examples as described herein. In some implementations, aspects of the operations of 1210 may be performed by a device as described with reference to FIG. 1.

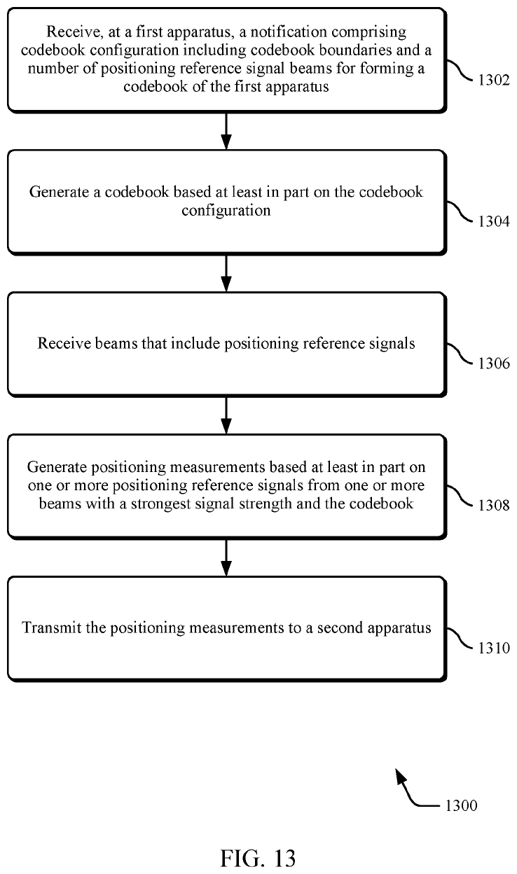

FIG. 13 illustrates a flowchart of a method 1300 that supports codebook configuration for device positioning in accordance with aspects of the present disclosure. The operations of the method 1300 may be implemented by a device or its components as described herein. For example, the operations of the method 1300 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1302, the method may include receiving, at a first apparatus, a notification comprising codebook configuration including codebook boundaries and a number of positioning reference signal beams for forming a codebook of the first apparatus. The operations of 1302 may be performed in accordance with examples as described herein. In some implementations, aspects of the operations of 1302 may be performed by a device as described with reference to FIG. 1.

At 1304, the method may include generating a codebook based at least in part on the codebook configuration. The operations of 1304 may be performed in accordance with examples as described herein. In some implementations, aspects of the operations of 1304 may be performed by a device as described with reference to FIG. 1.

At 1306, the method may include receiving beams that include positioning reference signals. The operations of 1306 may be performed in accordance with examples as described herein. In some implementations, aspects of the operations of 1306 may be performed by a device as described with reference to FIG. 1.

At 1308, the method may include generating positioning measurements based at least in part on one or more positioning reference signals from one or more beams with a strongest signal strength and the codebook. The operations of 1308 may be performed in accordance with examples as described herein. In some implementations, aspects of the operations of 1308 may be performed by a device as described with reference to FIG. 1.

At 1310, the method may include transmitting the positioning measurements to a second apparatus. The operations of 1310 may be performed in accordance with examples as described herein. In some implementations, aspects of the operations of 1310 may be performed by a device as described with reference to FIG. 1.

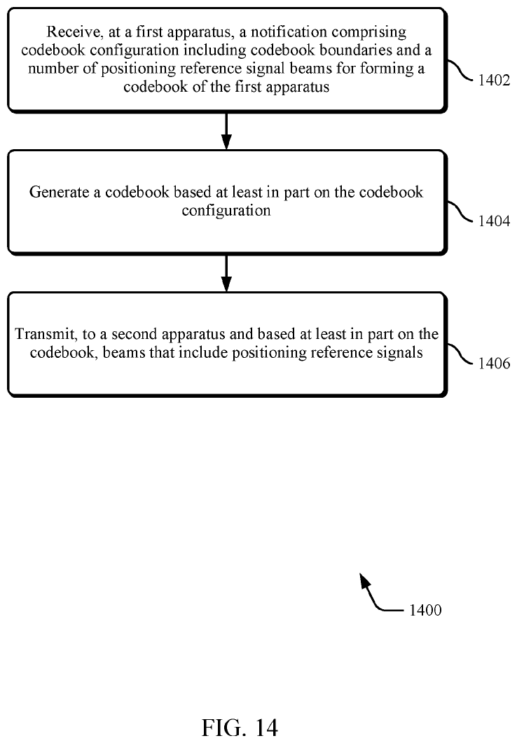

FIG. 14 illustrates a flowchart of a method 1400 that supports codebook configuration for device positioning in accordance with aspects of the present disclosure. The operations of the method 1400 may be implemented by a device or its components as described herein. For example, the operations of the method 1400 may be performed by a network entity 102 and/or a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1402, the method may include receiving, at a first apparatus, a notification comprising codebook configuration including codebook boundaries and a number of positioning reference signal beams for forming a codebook of the first apparatus. The operations of 1402 may be performed in accordance with examples as described herein. In some implementations, aspects of the operations of 1402 may be performed by a device as described with reference to FIG. 1.

At 1404, the method may include generating a codebook based at least in part on the codebook configuration. The operations of 1404 may be performed in accordance with examples as described herein. In some implementations, aspects of the operations of 1404 may be performed by a device as described with reference to FIG. 1.

At 1406, the method may include transmitting, to a second apparatus and based at least in part on the codebook, beams that include positioning reference signals. The operations of 1406 may be performed in accordance with examples as described herein. In some implementations, aspects of the operations of 1406 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and operable to cause the network entity to:
generate a notification comprising codebook configuration including codebook boundaries and a number of positioning reference signal features for forming a codebook of a user equipment (UE), the number of positioning reference signal features based at least in part on one or more criteria;
transmit the notification to the UE;
receive positioning measurements generated by the UE based at least in part on the codebook configuration; and
generate a position estimate of the UE based at least in part on the positioning measurements.

2. The network entity of claim 1, wherein the number of positioning reference signal features comprise one or more of a number of positioning reference signal codewords per dimension or a number of positioning reference signal beams per dimension.

3. The network entity of claim 1, wherein the one or more criteria comprise one or more of:
one or more capabilities of the UE;
one or more positioning accuracy features of the network entity;
a power usage parameter of the UE;
a maximum delay parameter of the network entity;
a mobility status of the UE;
the codebook boundaries of the UE; or
a positioning reference signal time-frequency resource configuration of the UE.

4. The network entity of claim 1, wherein the at least one processor is operable to cause the network entity to transmit positioning reference signals to the UE.

5. The network entity of claim 1, wherein the at least one processor is operable to cause the network entity to generate the position estimate of the UE as one or more of:
an absolute position of the UE;
a relative position of the UE; or
a range estimate comprising of one or more of a distance or a relative direction with respect to one or more of the network entity or an apparatus that transmits positioning reference signals to the UE.

6. The network entity of claim 1, wherein the positioning measurements are based at least in part on one or more of uplink, downlink, or sidelink positioning measurements.

7. The network entity of claim 1, wherein the at least one processor is operable to cause the network entity to:
receive an indication of a change in the one or more criteria; and
dynamically adjust the codebook configuration based on the change in the one or more criteria.

8. A user equipment (UE) for wireless communication, comprising:
at least one memory; and
at least one processor coupled with the at least one memory and operable to cause the UE to:
receive a notification comprising codebook configuration including codebook boundaries and a number of positioning reference signal features for forming a codebook of the UE;
generate a codebook based at least in part on the codebook configuration;
receive positioning reference signals;
generate positioning measurements based at least in part on the positioning reference signals and the codebook; and
transmit the positioning measurements to an apparatus.

9. The UE of claim 8, wherein the number of positioning reference signal features comprise one or more of a number of positioning reference signal codewords per dimension or a number of positioning reference signal beams per dimension.

10. The UE of claim 8, wherein to generate the positioning measurements the at least one processor is operable to cause the UE to use codewords forming the codebook to process the positioning reference signals.

11. The UE of claim 10, wherein the at least one processor is operable to cause the UE to process one or more paths of channel impulse responses (CIR) to generate the positioning measurements.

12. The UE of claim 11, wherein the at least one processor is operable to cause the UE to generate the positioning measurements using one or more codebook-based methods.

13. The UE of claim 12, wherein the one or more codebook-based methods comprise multiple signal classification (MUSIC).

14. The UE of claim 8, wherein the at least one processor is operable to cause the UE to generate the positioning measurements based at least in part on one or more of uplink, downlink, or sidelink positioning measurements.

15. The UE of claim 8, wherein the apparatus comprises one or more of an apparatus that transmits the notification or an apparatus that transmits the positioning reference signals.

16. (canceled)

17. A network entity for wireless communication, comprising:
at least one memory; and
at least one processor coupled with the at least one memory and operable to cause the network entity to:
generate a first notification comprising a codebook configuration of a user equipment (UE) including codebook boundaries and a number of positioning reference signal beams for forming a codebook of the UE, the number of positioning reference signal beams based at least in part on a first set of criteria;
generate a second notification comprising a codebook configuration of one or more third apparatus including codebook boundaries and a number of positioning reference signal beams for forming a codebook of the one or more third apparatus, the number of positioning reference signal beams based at least in part on a second set of criteria;
transmit the first notification to the UE, and the second notification to the one or more third apparatus;
receive positioning measurements generated by the UE based at least in part on the codebook configuration of the UE; and
generate a position estimate of the UE based at least in part on the positioning measurements.

18. The network entity of claim 17, wherein one or more of the first set of criteria or the second set of criteria comprise one or more of:
at least one of one or more capabilities of the UE or one or more capabilities of the one or more third apparatus;
one or more positioning accuracy features of the network entity;
one or more of a power usage parameter of the UE or a power usage parameter of the one or more third apparatus;
a maximum delay parameter of the network entity;
one or more of a mobility status of the UE or a mobility status of the one or more third apparatus;
one or more of the codebook boundaries of the UE or the codebook boundaries of the one or more third apparatus; or
one or more of a positioning reference signal time-frequency resource configuration of the UE or a positioning reference signal time-frequency resource configuration of the one or more third apparatus.

19. The network entity of claim 17, wherein the at least one processor is operable to cause the network entity to generate the position estimate of the UE as one or more of:
an absolute position of the UE;
a relative position of the UE; or
a range estimate comprising of one or more of a distance or a relative direction with respect to one or more of the network entity or an apparatus that transmits positioning reference signals to the UE.

20. The network entity of claim 17, wherein the positioning measurements are based at least in part on one or more of uplink, downlink, or sidelink positioning measurements.

21. A method performed by a user equipment (UE), the method comprising:
receiving a notification comprising codebook configuration including codebook boundaries and a number of positioning reference signal features for forming a codebook of the UE;
generating a codebook based at least in part on the codebook configuration;
receiving positioning reference signals;
generating positioning measurements based at least in part on the positioning reference signals and the codebook; and
transmitting the positioning measurements to an apparatus.
